(19) United States
(12) Patent Application Publication
(10) Pub. No.: US 2020/0005027 A1
(43) Pub. Date: Jan. 2, 2020

(54) WEIGHT TRAINING INTELLIGENCE SYSTEM

(71) Applicant: CHENG-KUN LEE, Taichung City (TW)

(72) Inventor: CHENG-KUN LEE, Taichung City (TW)

(73) Assignee: Johnson Health Tech Co., Ltd., Taichung City (TW)

(21) Appl. No.: 16/021,010

(22) Filed: Jun. 27, 2018

(51) Int. Cl. G06K 9/00; A63B 21/072; G06T 7/20; G09B 19/00

(52) U.S. Cl. CPC G06K 9/00355; A63B 21/0726; A63B 2230/06; G09B 19/003; A63B 2220/17; G06T 7/20

(57) ABSTRACT

A weight training intelligence system that uses image recognition algorithms to provide weight training information for a user includes a dumbbell set including a plurality of dumbbells, an image capturing device and a processor. The image capturing device defines a capturing area. The image capturing device is configured to capture images of the dumbbells and to capture moving images of a user while using dumbbells within the capturing area. The processor is electrically connected to the image capturing device. The processor includes a dumbbell identification unit, a movement tracking unit and an analyzing unit. The dumbbell identification unit is configured to identify weights of the dumbbells according to the images of the dumbbells. The movement tracking unit is configured to track movement of the user according to the moving images of the user. The analyzing unit is configured to analyze postures of the user while using the dumbbells via the image recognition algorithms according to the images of the dumbbells and the moving images of the user so as to provide training information for the user.

### BACKGROUND

### 1. Field of the Invention

The present invention relates to a weight training intelligence system. More particularly, the present invention relates to a system that uses image recognition algorithms to provide weight training information for a user.

### 2. Description of the Related Art

Weight training is a common type of strength training for developing the strength and size of skeletal muscles. It utilizes the force of gravity in the form of weighted bars, dumbbells or weight stacks in order to oppose the force generated by muscle through concentric or eccentric contraction. Weight training uses a variety of specialized equipment to target specific muscle groups and different types of movement.

The correctness of body movements and the movement of dumbbells during weight training will affect effectiveness of the training and avoid sport injury. Therefore, it is necessary to improve and correct the user's weight training movement and the movement of dumbbells at any time. If there is a weight training system, it can be operable to determine whether the movement path and movement posture are correct to provide assistance and train the user in correct movement.

### SUMMARY

The object of the present invention provides weight training intelligence system that uses image recognition algorithms to provide weight training information for a user.

According to one aspect of the present invention, a weight training intelligence system that uses image recognition algorithms to provide weight training information for a user includes a dumbbell set including a plurality of dumbbells, an image capturing device and a processor. The image capturing device defines a capturing area. The image capturing device is configured to capture images of the dumbbells and to capture moving images of a user while using dumbbells within the capturing area. The processor is electrically connected to the image capturing device. The processor includes a dumbbell identification unit, a movement tracking unit, and an analyzing unit. The dumbbell identification unit is configured to identify weights of the dumbbells according to the images of the dumbbells. The movement tracking unit is configured to track movement of the user according to the moving images of the user. The analyzing unit is configured to analyze postures of the user while using the dumbbells via the image recognition algorithms according to the images of the dumbbells and the moving images of the user so as to provide training information for the user.

Preferably, the dumbbell identification unit is operable to identify the weight of each of the dumbbells according to a mark on each of the dumbbells or according to dimensions of each of the dumbbells or according to a position of each of the dumbbells on a dumbbell rack.

Preferably, the processor further includes a user recognition unit configured to recognize the user who uses the dumbbells.

Preferably, the processor further includes a heart rate measuring unit configured to measure the heart rate of the user by tracking a specific region of the user through the image capturing device.

Preferably, the weight training intelligence system further includes a memory configured to store the images of the dumbbells and the moving images of the user. The memory may further stores dumbbell training instructions for comparing with the postures of the user so as to provide the training information.

Preferably, the weight training intelligence system further includes an information output device electrically connected to the processor. The information output device is configured to provide individual training information for the user.

Furthermore, the processor may further include an abnormality detection unit configured to detect abnormal behavior of the user within the capturing area and to detect whether the dumbbells are out of position.

Further benefits and advantages of the present invention will become apparent after a careful reading of the detailed description with appropriate reference to the accompanying drawings.

### DETAIL DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of a weight training intelligence system provided for tracking dumbbells and movement posture of a user is disclosed. The weight training intelligence system is generally provided for in a gym. For example, the weight training intelligence system is able to recognize weights of the dumbbells and to track movement of the user while using the dumbbells so as to provide dumbbell training information for the user. In the embodiment of the present invention, the weight training intelligence system includes at least one image capturing device such as cameras used to take photographs or record images. The image capturing device defines a capturing area for capturing images of objects within the capturing area. The weight training intelligence system also includes a dumbbell set arranged within the capturing area such that the image capturing device is able to capture images of the dumbbells within the capturing area. The dumbbell set includes a plurality of dumbbells such as eight pairs or ten pairs of different dumbbells positioned on a dumbbell rack in order. When a user performs dumbbell workout within the capturing area, the image capturing device is also capable of capturing moving images of the user while using the dumbbells within the capturing area.

The weight training intelligence system includes a processor and a memory. The processor is electrically connected to the image capturing device and interacting with the memory. The processor is configured for receiving and processing images captured from the image capturing device. In one embodiment, the processor includes a dumbbell identification unit, a movement tracking unit, and an analyzing unit. The dumbbell identification unit is configured to identify weights of the dumbbells according to the images of the dumbbells captured by the image capturing device. For example, each of the dumbbells includes a numeral mark such as 501b, 401b, 301b on the outer sides of each dumbbell for representing weight of each dumbbell, and the dumbbell identification unit of the processor is capable of recognizing the numeral mark on the corresponding dumbbell so as to determine the weight of the corresponding dumbbell. Otherwise, the dumbbells can also be marked with individual identification codes and the dumbbell identification unit is able to identify the identification code of the corresponding dumbbell to determine the weight of the corresponding dumbbell. For example, the dumbbell identification unit may compare the identification code of the corresponding dumbbell with a comparison table which is stored in the memory to know the actual weight of the corresponding dumbbell.

In another embodiment, the weight of each dumbbell may be calculated by the dumbbell identification unit through the dumbbell images captured by the image capturing device. The dumbbell identification unit is operable to identify the dimensions of each dumbbell to calculate the weight of the respective dumbbell. In general, the dumbbell includes two equal weights connected by a short bar or a handle. The short bars of the dumbbells are the same so the dumbbells have different weights depending on different sizes of the weights of the dumbbells. The diameter and depth of each weight of the respective dumbbell can be identified through the dumbbell images, so that the weight of the respective dumbbell can be roughly calculated.

In another embodiment of the present invention, the weight training intelligence system is generally applied to a full-set of fixed-weight dumbbells. The dumbbell rack is provided for allowing a plurality of dumbbells to be positioned in position, namely each dumbbell is generally placed on its individual position. Therefore, the dumbbell identification unit is able to identify the weight of each dumbbell according to the position of each dumbbell on the dumbbell rack. For example, the dumbbell identification unit is operable to determine the weight of the dumbbell used by the user according to the determination of which dumbbells are not in position or a gym manager is able to know which dumbbells are in use.

The movement tracking unit of the processor is configured to track movement of the user while performing dumbbell workout. The movement tracking unit is able to track the movement of the user according to the moving images of the user captured by the image capturing device such as the variations of the curved angles of the upper arm and the lower arm of the user when performing dumbbell concentration curl. The analyzing unit of the processor is configured to analyze postures of the user while using the dumbbells for providing training information for the user. For example, the analyzing unit of the processor is capable of analyzing the above-mentioned postures of the user via the image recognition algorithms according to the images of the dumbbells and the moving images of the user.

In addition to the images of the dumbbells and the moving images of the user, the memory may also store dumbbell training instructions. The analyzing unit is operable to compare the postures of the user with the dumbbell training instructions for providing training information to the user. For example, the training information is suggested training information. In one embodiment of the present invention, the weight training intelligence system further comprises an information output device and the processor is electrically connected thereto. The information output device is configured to provide individual training information for the user. For example, the user is able to download the individual training information or the analyzing result through the information output device to a mobile device or any display device for allowing the user to read or view the individual training information such as training repetitions, training motion analysis result, or the combination thereof.

The processor further includes a user recognition unit configured to recognize the user who uses the dumbbells. In one embodiment of the present invention, for example, the user recognition unit is able to recognize different users via a facial recognition system. The user recognition unit could recognize one or more users by using the image recognition algorithms, so that the weight training intelligence system is able to record training activities of one or more users at the same time. Therefore, when one or more persons perform dumbbell workout within the capturing area of the image capturing device, the weight training intelligence system is able to provide training information for each person.

Moreover, in another embodiment, the processor includes a heart rate measuring unit configured to measure the heart rate of the user by tracking a specific region of the user such as the user's face through the image capturing device over time to take pulse measurements when the user uses the dumbbells. For example, the heart rate measuring unit is able to measure the user's pulse remotely according to variation of the pixel information of the user's face image captured by the image capturing device. The technology for measuring user's pulse from pixel information captured by digital cameras is able to be achieved by using the image recognition algorithms. Under this arrangement, the weight training intelligence system is able to provide individual training information of dumbbell weight, training repetitions, user's movement path, training instruction, heart rate, or the combination thereof.

The processor further includes an abnormality detection unit configured to detect abnormal behavior of users within the capturing area and to detect whether the dumbbells are out of position. For example, when the user gets hurt or faints during dumbbell training, the use's behavior or posture may be abnormal, and the abnormality detection unit could detect such abnormal behavior of the user to ensure training safety immediately. In this manner, the gym manager can be aware of any accident occurred within the capturing area of the image capturing device. In addition, the abnormality detection unit is also provided for allowing the gym manager to detect whether the dumbbells are out of position so as to track the dumbbells conveniently.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A weight training intelligence system, comprising:
a dumbbell set comprising a plurality of dumbbells;
an image capturing device defining a capturing area, the image capturing device configured to capture images of the dumbbells and capturing moving images of a user while using the dumbbells within the capturing area; and
a processor electrically connected to the image capturing device, the processor comprising a dumbbell identification unit, a movement tracking unit, and an analyzing unit, the dumbbell identification unit configured to identify weights of the dumbbells according to the images of the dumbbells, the movement tracking unit configured to track movement of the user according to the moving images of the user, the analyzing unit configured to analyze postures of the user while using the dumbbells via the image recognition algorithms according to the images of the dumbbells and the moving images of the user so as to provide a training information for the user.

2. The weight training intelligence system as claimed in claim 1, wherein each of the dumbbells comprises a mark thereon for representing a weight of the each of the dumbbells, and the dumbbell identification unit is operable to recognize the mark to determine the weight of the each of the dumbbells.

3. The weight training intelligence system as claimed in claim 1, wherein the dumbbell identification unit is operable to calculate a weight of each of the dumbbells according to dimensions of the each of the dumbbells.

4. The weight training intelligence system as claimed in claim 1, further comprising a dumbbell rack on which the dumbbells can put in position, and wherein the dumbbell identification unit is operable to identify a weight of each of the dumbbells according to a position of the each of the dumbbells on the dumbbell rack.

5. The weight training intelligence system as claimed in claim 1, wherein the processor further comprises a user recognition unit configured to recognize the user who uses the dumbbells.

6. The weight training intelligence system as claimed in claim 1, wherein the processor further comprises a heart rate measuring unit configured to measure the heart rate of the user by tracking a specific region of the user through the image capturing device.

7. The weight training intelligence system as claimed in claim 1, further comprising a memory configured to store the images of the dumbbells and the moving images of the user.

8. The weight training intelligence system as claimed in claim 7, wherein the memory further stores dumbbell training instructions for comparing with the postures of the user so as to provide the training information for the user.

9. The weight training intelligence system as claimed in claim 1, further comprising an information output device electrically connected to the processor, the information output device configured to provide an individual training information for the user.

10. The weight training intelligence system as claimed in claim 1, wherein the processor further comprises an abnormality detection unit configured to detect an abnormal behavior of the user within the capturing area and to detect whether the dumbbells are out of position.

11. A system that uses image recognition algorithms to provide a training information for a user, the system comprising:
a plurality of dumbbells;
an image capturing device defining a capturing area, the image capturing device configured to capture images of the dumbbells and capture moving images of the user while using the dumbbells within the capturing area;
a memory storing the images of the dumbbells and the moving images of the user; and
a processor interacting with the memory and configured to identify weights of the dumbbells from the images of the dumbbells, to track movement of the user while using the dumbbells according to the moving images of the user, to analyze postures of the user during dumbbell training, and to provide the training information for the user; and
wherein the training information comprises at least one of the weights of the dumbbells used by the user and a movement path of the user.

12. The system as claimed in claim 11, wherein each of the dumbbells comprises a mark thereon for representing the weight of the each of the dumbbells, and the processor is configured to recognize the mark on the each of the dumbbells so as to determine the weight of the each of the dumbbells.

13. The system as claimed in claim 11, wherein the processor is configured to calculate the weight of each of the dumbbells according to dimensions of the each of the dumbbells.

14. The system as claimed in claim 11, further comprising a dumbbell rack on which the dumbbells can put in position, and wherein the processor is configured to identify a weight of each of the dumbbells according to the position of the each of the dumbbells on the dumbbell rack.

15. The system as claimed in claim 11, wherein the processor is configured to recognize the user who uses the dumbbells.

16. The system as claimed in claim 11, wherein the processor is configured to measure the heart rate of the user by tracking a specific region of the user through the image capturing device.

17. The system as claimed in claim 11, wherein the memory further stores dumbbell training instructions so that the processor is able to compare the postures of the user with the dumbbell training instructions for providing the training information.

18. The system as claimed in claim 11, further comprising an information output device configured to provide an individual training information for the user.

19. The system as claimed in claim 11, wherein the processor is configured to detect an abnormal behavior of the user within the capturing area and to detect whether the dumbbells are out of position.
